(19) United States
(12) Patent Application Publication
(10) Pub. No.: US 2016/0281410 A1
(43) Pub. Date: Sep. 29, 2016

(54) APPARATUS AND METHOD FOR OPENING A VEHICLE GATE USING A CAMERA

(71) Applicant: Continental Automotive Systems, Inc., Auburn Hills, MI (US)

(72) Inventors: Holger Schanz, Lake Orion, MI (US); Zachary Bolton, Birmingham (UA); Rohollah Mazrae, Rochester (UA); Brian Fischer, Clarkston, MI (US); Alberto Ramirez-Mendez, Pontiac (UA)

(21) Appl. No.: 15/077,467

(22) Filed: Mar. 22, 2016

Related U.S. Application Data
(60) Provisional application No. 62/137,032, filed on Mar. 23, 2015.

(51) Int. Cl. E05F 15/73; E05B 81/16; E05B 83/36; B60R 25/24; B60J 5/10

(52) U.S. Cl. CPC E05F 15/73; B60R 25/24; B60J 5/101; E05B 83/36; E05B 81/16; E05F 2015/767

(57) ABSTRACT

A gate opening system for a vehicle comprises a gate for the vehicle moveable between an open position and a closed position relative to a vehicle body and a gate actuator secured to the vehicle and the gate to actuate movement of the gate between the open position and the closed position. A camera is mounted to the vehicle and facing in an external direction provide a view of an area proximate to the vehicle. An ECU is connected to the camera to detect a predetermined action by a vehicle operator based upon image analysis of the camera image. A remote keyless entry system is also connected to the ECU and the gate actuator, wherein the remote keyless entry system activates the gate actuator to move the gate from the closed position to the open position when the ECU determines that the predetermined action has occurred.

### CROSS-REFERENCE TO RELATED APPLICATIONS

This disclosure claims priority to U.S. Provisional Application No. 61/930,044, which was filed on Jan. 22, 2014 and is incorporated herein by reference.

### TECHNICAL FIELD

The present disclosure relates to automotive vehicles and more particularly to assistance devices for automotive vehicles.

### BACKGROUND

Rear view mirror and backup camera systems are used to assist a driver in backing up a vehicle and to view vehicles located behind them. Backup camera systems typically are used to view areas immediately behind the vehicle when the vehicle is in reverse. The camera may be mounted to a rear gate for the vehicle.

Actuating hands free opening of a trunk or rear gate has been provided. The actuation is initiated by a sensor mounted underneath the vehicle which detects contact with the vehicle with a foot. The sensor provided to detect contact is additional hardware to provide this option.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A gate opening system for a vehicle comprises a gate for the vehicle moveable between an open position and a closed position relative to a vehicle body and a gate actuator secured to the vehicle and the gate to actuate movement of the gate between the open position and the closed position. A camera is mounted to the vehicle and facing in an external direction provide a view of an area proximate to the vehicle. An ECU is connected to the camera to detect a predetermined action by a vehicle operator based upon image analysis of the camera image. A remote keyless entry system is also connected to the ECU and the gate actuator, wherein the remote keyless entry system activates the gate actuator to move the gate from the closed position to the open position when the ECU determines that the predetermined action has occurred.

A method of controlling a gate opening for a vehicle comprises recording an area proximate to the vehicle with a camera mounted to the vehicle and facing in an external direction and performing image analysis of an image from the camera with an ECU for the gate opening system to detect a predetermined action of a vehicle operator recorded by the camera has occurred. A gate actuator is actuated with a remote keyless entry system to move a gate from a closed position to an open position when the ECU determines that the predetermined action has occurred.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic illustration of a vehicle of the present invention with a gate opening system utilizing a camera to provide opening of a rear gate;

FIG. 1A is a schematic illustration of key fob for use with the gate opening system of FIG. 1; and

FIG. 2 is a schematic illustration of a vehicle of the present invention with the gate opening system utilizing a camera to provide opening of a side gate;

### DETAILED DESCRIPTION

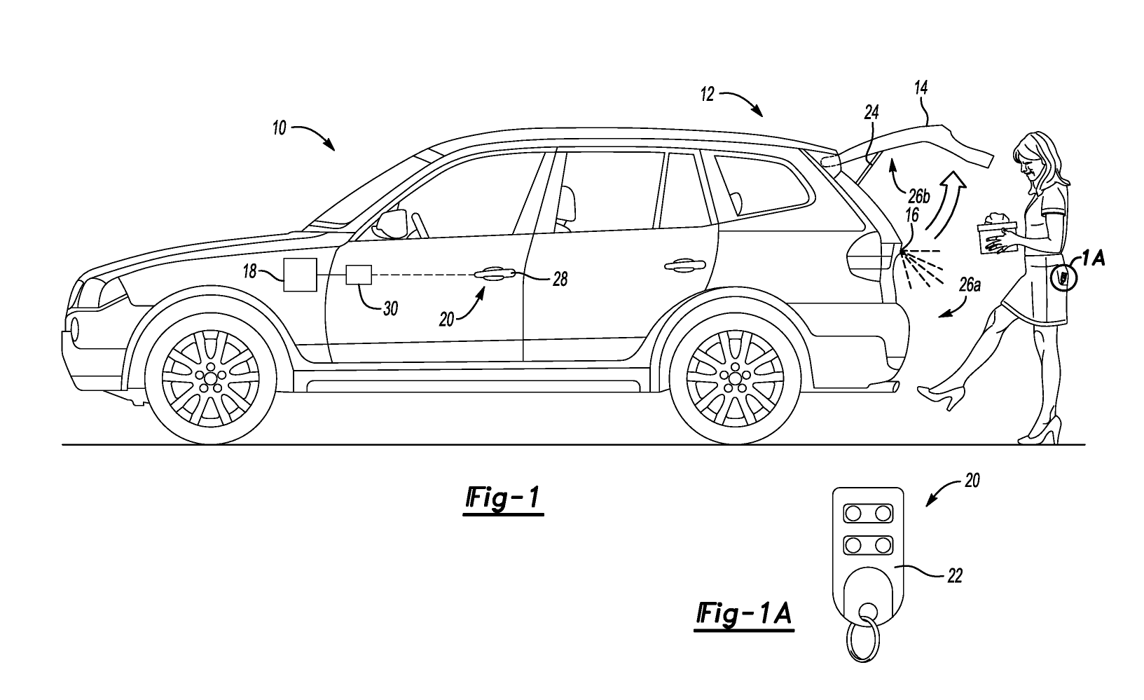

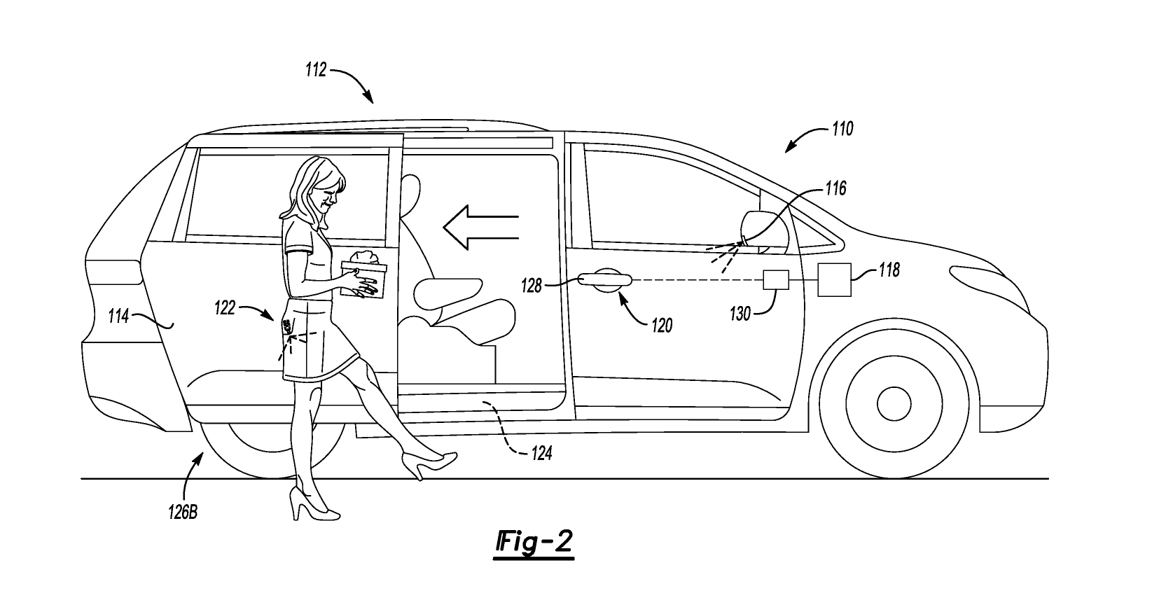

The following description is merely exemplary in nature and is in no way intended to limit the disclosure, its application, or uses. For purposes of clarity, the same reference numbers will be used in the drawings to identify similar elements. FIGS. 1 and 2 illustrate vehicles 10, 110 and a gate opening system 12, 112 of the present invention. The gate opening system 12, 112 includes a camera 16, 116. The camera 16 can be mounted to or proximate to a rear gate 14 of the vehicle 10. Alternatively, the camera 116 can be mounted proximate to a side gate 114, i.e. door, such as on a side view mirror or A-pillar of the vehicle 110. Throughout the application the term gate is intended to refer to a trunk style gate, an upward rotating lift style gate, e.g. SUV or mini-van style rear lift gates, or downward rotating lift style gate, e.g. open truck bed style. Alternatively the gate could be a side gate, such as a side door on the driver or passenger side of the vehicle 10 which slides open. A gate 14, 114 opening system is described herein as, typically, the storage compartment in a vehicle 10 is located at the rear of the vehicle 10 and the engine compartment is at the front. However, the apparatus and method of the current invention for providing hands free opening of the storage compartment may also be used by a front location storage compartment with a forward looking camera or a side entry door for vehicles 110 with a side facing camera 116.

The camera 16, 116 is mounted to view an external rear or side environment proximate to the vehicle 10, 110. Preferably, the camera 16, 116 is also utilized by other systems such as a backup viewing, park assist systems, surround view, mirror replacement, etc. The camera 16, 116 is connected to an ECU 18, 118 which receives the image viewed by the camera. The ECU 18, 118 is capable of performing image analysis of the image for the gate opening system 12, 112, and may also control and perform image analysis for other vehicle systems as well. For the gate opening system 12, 112 the image analysis may include comparing contrasting light and shadow in the image created by the movement of the operator's foot relative to the background, i.e. the ground behind/beside the vehicle 10, 110 which the operator is standing on. The ECU 18, 118 can be programmed to perform the image analysis based on a profile which matches a specific movement, such as the operator may swing their foot, lift their knee, etc.

A remote keyless entry system 20, 120 is used to activate a vehicle locking system as a vehicle operator approaches. The remote keyless entry system 20, 120 includes a key fob 22, 122 which wirelessly communicates with the ECU 18, 118. The ECU 18, 118 may be the same ECU 18, 118 which performs the image analysis or a different ECU. The ECU 18, 118 and key fob 22, 122 perform a handshake operation as the key fob 22, 122 is moved into a desired proximity to the vehicle 10, 110 whereby the ECU 18, 118 confirms that the key fob 22, 122 is present and initiates the vehicle locking system to unlock the vehicle 10, 110 when predetermined actions from the operator are detected. The side and rear gates 14, 114 are then unlocked when any of the predetermined actions from the operator are detected. The remote keyless entry system 20, 120 may also perform additional operations beyond unlocking the doors based upon the predetermined action detected. For example, when detection of the operator grabbing a door handle is detected all or some of the vehicle door's may be unlocked, but when foot movement at one of the door or gate locations 14, 114 is detected the remote keyless entry system 20, 120 may also actuate opening of the door or gate 14, 114 at that corresponding location.

Further, the gate opening system 12, 112 can use the location of the key fob 22, 122 to turn on the camera 16, 116 closest to that location. That is, if the key fob 22 is detected at the back of the vehicle 10 the rear camera 16 is activated. However, when the key fob 122 is detected on the side of the vehicle 110, the side camera 116 is activated. Alternately, all external view cameras 16, 116 used by the gate opening system 12, 112 can be activated when the key fob 22, 122 presence is detected.

One predetermined action may be movement of the operator's foot at the rear or side gate locations 14, 114. The gate opening system 12, 112 uses the camera 16, 116 and ECU 18, 118 to detect movement of the operator's foot at the rear or side gate location 14, 114. The predetermined action is confirmed using the image analysis. Positive detection of the predetermined action is reported to and used by the remote keyless entry system 20 to then actuate opening the rear gate 14. Some or all of the door locations may also be actuated to unlock at the same time.

A method of controlling the gate 14, 114 opening for the vehicle 10, 110 comprises recording an area proximate to the vehicle 10, 110 with the camera 16, 116, which is mounted to the vehicle 10, 110 and facing in an external direction. Image analysis of the image from the camera is performed by an ECU 18, 118 for the gate opening system 12, 112 to detect a predetermined action of the vehicle operator. A gate actuator 24, 124 is activated with the remote keyless entry system 20, 120 to move the gate 14, 114 from a closed position 26A, 126A to an open position 26B, 126B when the ECU 18, 118 determines that the predetermined action has occurred.

The gate opening system 12, 112 may also have a latching mechanism 28, 128 for the gate 14, 14. The latching mechanism 28, 128 is moveable between a locked position and an unlocked position. A latch actuator 30, 130 is secured to the vehicle 10, 110 and the latching mechanism 28, 128 to actuate movement of the latching mechanism 28, 128 between the locked position and the unlocked position. The remote keyless entry system 20, 120 activates the latch actuator 30, 130 to move the latch mechanism 28, 128 from the locked position to the unlocked and released position when the ECU 18, 118 determines that the predetermined action has occurred and prior to activating the gate actuator 24, 124.

For downward rotating style lift gates, i.e. open truck bed style, the gate actuator 24, 124 may not be necessary as once the latch is released gravity may be sufficient to move the lift gate 14, 114 to the open position 26B, 126B. Alternately, the gate actuator 24, 124 may be a small actuator sufficient to initiation motion of the lift gate 14, 114 and allowing gravity to complete the motion.

The remote keyless entry system 20, 120 is used to determine when the key fob 22, 122 is within the predetermined distance from the vehicle 10 and activates the camera 16, 116 to begin recording an image for analysis to detect presence of the vehicle operator and a request to open a desired gate, 14, 114, e.g. by detecting movement of the operators foot.

While the best modes for carrying out the invention have been described in detail the true scope of the disclosure should not be so limited, since those familiar with the art to which this invention relates will recognize various alternative designs and embodiments for practicing the invention within the scope of the appended claims.

What is claimed is:

1. A gate opening system for a vehicle comprising:
a gate for the vehicle moveable between an open position and a closed position relative to a vehicle body;
a gate actuator secured to the vehicle and the gate to actuate movement of the gate between the open position and the closed position;
a camera mounted to the vehicle and facing in an external direction provide a view of an area proximate to the vehicle;
an ECU connected to the camera to detect a predetermined action by a vehicle operator based upon image analysis of the camera image;
a remote keyless entry system connected to the ECU and the gate actuator, wherein the remote keyless entry system activates the gate actuator to move the gate from the closed position to the open position when the ECU determines that the predetermined action has occurred.

2. The gate opening system of claim 1, further comprising:
a latching mechanism for the gate, wherein the latching mechanism is moveable between a locked position and an unlocked position;
a latch actuator secured to the vehicle and the latching mechanism to actuate movement of the latching mechanism between the locked position and the unlocked position; and
wherein the remote keyless entry system activates the latch actuator to move the latch from the locked position to the unlocked position when the ECU determines that the predetermined action has occurred and prior to activating the gate actuator.

3. The gate opening system of claim 1, wherein the ECU activates the camera when the remote keyless entry system determines that a key fob for the remote keyless entry systems is within a predetermined distance from the vehicle.

4. The gate opening system of claim 1, wherein the gate is one of a rear lift style gate and a rear trunk style gate, and wherein the camera is a rear facing camera also utilized by another vehicle system.

5. The gate opening system of claim 1, wherein the camera is mounted to the gate.

6. The gate opening system of claim 1, wherein the gate is a side sliding style gate, and wherein the camera is a side facing camera also utilized by another vehicle system.

7. The gate opening system of claim 1, wherein the camera is mounted to one of a side view mirror of the vehicle, and proximate to an A-pillar of the vehicle.

8. A method of controlling a gate opening for a vehicle comprising:
recording an area proximate to the vehicle with a camera mounted to the vehicle and facing in an external direction;
performing image analysis of an image from the camera with an ECU for the gate opening system to detect a predetermined action of a vehicle operator recorded by the camera has occurred; and
activating a gate actuator with a remote keyless entry system to move a gate from a closed position to an open position when the ECU determines that the predetermined action has occurred.

9. The method of claim 8, further comprising actuating movement of a latching mechanism between a locked position and a unlocked position the ECU determines that the predetermined action has occurred and prior to the remote keyless entry system activating the gate actuator.

10. The method of claim 8, further comprising:
determining with the remote keyless entry system that a key fob is within a predetermined distance from the vehicle; and
activating the camera to record when the remote keyless entry system determines that the key fob is within the predetermined distance from the vehicle.
The gate opening system of claim 1, wherein the gate is one of a rear lift style gate and a rear trunk style gate, and wherein the camera is a rear facing camera also utilized by another vehicle system.

11. The method of claim 8, wherein the camera is mounted to the gate.

12. The method of claim 8, wherein the gate is a side sliding style gate, and wherein the camera is a side facing camera also utilized by another vehicle system.

13. The method of claim 8, wherein the camera is mounted to one of a side view mirror of the vehicle, and proximate to an A-pillar of the vehicle.
